(19) United States
(12) Patent Application Publication
(10) Pub. No.: US 2011/0075620 A1
(43) Pub. Date: Mar. 31, 2011

(54) METHOD FOR CONTROLLING DATA AND SIGNAL IN A MOBILE COMMUNICATION SYSTEM

(75) Inventors: Su Young Jang, Gyeonggi-do (KR); Gyeong Yeol Lee, Gyeonggi-do (KR)

(73) Assignee: Su Young Jang, Gyeonggi-do (KR)

(21) Appl. No.: 12/663,540

(22) PCT Filed: Jun. 11, 2008
(86) PCT No.: PCT/KR2008/003266

§ 371 Date: Dec. 8, 2009

(30) Foreign Application Priority Data
Jun. 11, 2007 (KR) 10-2007-0056972
Jun. 21, 2007 (KR) 10-2007-0061309

(51) Int. Cl. H04W 72/04

(52) U.S. Cl. 370/329

(57) ABSTRACT

The present invention relates to a method of controlling data and signal transmission in a mobile communication system, and more particularly, to a method of performing random access efficiently and a method of delivering a discard information of radio link data more quickly.

### TECHNICAL FIELD

The present invention relates to a method of controlling data and signal transmission in a mobile communication system, and more particularly, to a method of performing random access and a method of delivering a discard information of radio link data.

### BACKGROUND OF THE INVENTION

1. Industrial Applicability

This invention can be applied to data and signal transmission in a mobile communications system.

2. Description of the Related Art

The present invention relates to a method of controlling data and signal transmission in a mobile communication system, and is more effectively applicable to performing random access procedure and delivering packet discard information in a mobile communication system. Particularly, the present invention is applicable to a method of efficiently processing random access preamble and corresponding response message when performing random access procedure in a mobile communication system. Moreover, the present invention is applicable to a method of efficiently processing packet discard when packet transmission is failed.

The LTE (Long Term Evolution) technology has evolved from a conventional 3rd generation mobile communication system (e.g. WCDMA, HSDPA) improving frequency efficiency and composing optimized network.

In a LTE system, a bandwidth varies from 1.25 MHz to 20 MHz comparing conventional 5 MHz fixed bandwidth. Moreover, OFDM (Orthogonal Frequency Division Multiplexing), MIMO (Multiple Input Multiple Output: MIMO), and smart antenna technologies are applied to LTE for data transmission of up to 100 Mbps in downlink and 50 Mbps in uplink.

In the LTE system, a MAC (Media Access Control) layer in a eNodeB requires HARQ (Hybrid Automatic Repeat request) function and a RLC (Radio Link Control) layer in the eNodeB requires ARQ (Automatic Repeat request) function to provides a desired service quality sustaining transmission link reliability between established endpoints.

In the LTE system, HARQ and ARQ functions may provide lossless packet data transmission and minimized transmission delay followed by packet re-transmission.

In the LTE system, a system performance may be improved by allocating resources (e.g. code, modulation scheme, frequencies) adaptively corresponding to channel circumstance.

However, a random access procedure in the conventional mobile communication system (e.g. WCDMA), takes a long time from transmitting random access preamble of a mobile terminal to establishing a channel for data transmission.

Hereinafter, examples of random access procedure in the conventional WCDMA system will be described.

A mobile terminal transmits random access preamble which includes a signature for distinguishing the mobile terminal before transmitting RACH message.

A base station transmits AICH (Acquisition Indication Channel) comprising the received signature information when the base station recognizes the random access preamble.

The mobile terminal transmits a RACH message (herein, the RACH message may be a RRC (Radio Resource Control) Connection Request message for establishing SRB (signaling radio bearer) to the base station when the mobile terminal receives the AICH. The base station transmits the received RACH message to a RNC (Radio Network Controller).

The RNC transmits RRC Connection Setup message comprising channel allocation information to the base station corresponding to the RRC Connection Request message. The base station transmits the RRC Connection Setup message which is mapped to S-CCPCH (Secondary Common Control Physical Channel) to the mobile terminal.

The mobile terminal establishes a dedicated channel using the received channel allocation information and transmits a RRC Connection Setup Complete message to the RNC via the base station through the established dedicated channel.

The random access procedure performs 3-way handshake process and the mobile terminal may transmits user data when the 3-way handshake process is completed.

Moreover, a packet scheduler in the MAC layer of transmitting side may re-transmit a TB (Transport Block) when transmitting the TB which comprises a part or whole RLC PDU is failed because of bad radio circumstance. In case of transmission failure up to pre-determined number, the MAC layer delivers the re-transmission failure information to the RLC layer of transmitting side.

The RLC layer of transmitting side tries to re-transmit the corresponding RLC PDU up to a pre-determined number. In case of re-transmission failure up to the pre-determined number, the RLC layer of transmitting side discards the corresponding RLC PDU and transmits discard information to the RLC layer of receiving side.

Accordingly, in case that the RLC layer of receiving side receives a discard information of the corresponding RLC PDU, it takes too much time to receive the discard information.

### BRIEF SUMMARY OF THE INVENTION

The present invention is directed to a method of performing random access in a mobile communication system, which substantially one or more problems due to limitations and disadvantages of the related art.

An object of the present invention is to provide a method of performing random access in a mobile communication system, in which radio resources are efficiently used in the mobile communication system.

To achieve the object and other advantages and in accordance with the purpose of the inventions, as embodied and broadly described herein, a method of performing random access in a mobile terminal of a mobile communication system which uses multiple carriers comprises obtaining random access parameter from a system information received from a base station, determining random access type using the obtained random access parameter, generating a random access preamble corresponding to the determined random access type, and transmitting the random access preamble to a base station.

In another aspect of the present invention, a method of performing transmission of control information in a mobile communication system comprises composing a control information which indicates a data discard, and transmitting the control information from a transmitting side.

It is to be understood that both the forgoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a network structure of an E-UMTS (Evolved-Universal Mobile Telecommunications System).

FIG. 2 and FIG. 3 illustrates a structure of a radio interface protocol between a mobile terminal and E-UTRAN, in which FIG. 2 is a schematic view of a control plane protocol and FIG. 3 is a schematic view of a user plane protocol.

FIG. 4 illustrates HARQ operation in 3GPP UTRAN (UMTS Terrestrial Radio Access Network).

FIG. 5 illustrates a method of packet discard which fails to re-transmit in RLC layer according to a conventional art.

FIG. 6 illustrates a method of packet discard which fails to re-transmit according to one embodiment of the present invention.

FIG. 7 is a flow chart illustrating a method of packet discard which fails to re-transmit according to one embodiment of the present invention.

FIG. 8 illustrates a CP inserting method for preventing inter-symbol interference and inter-channel interference.

FIG. 9 illustrates a structure of Basic RACH frame according to one embodiment of the present invention.

FIG. 10 illustrates a structure of Extended RACH frame according to one embodiment of the present invention.

FIG. 11 illustrates a structure of Repeated RACH frame according to one embodiment of the present invention.

FIG. 12 is a flow chart illustrating a random access procedure according to one embodiment of the present invention.

### DETAILED DESCRIPTION OF THE INVENTION

Hereinafter, structures, operations, and other features of the present invention will be understood readily by the preferred embodiments of the present invention, examples of which are illustrated in the accompanying drawings.

In accordance with one embodiment of the present invention, a method of performing random access in a mobile terminal of a mobile communication system comprises obtaining random access parameter from a system information received from a base station, determining random access type using the obtained random access parameter, generating a random access preamble corresponding to the determined random access type, and transmitting the random access preamble to a base station.

In accordance with one embodiment of the present invention, a method of transmitting control information in a MAC (Medium Access Control) layer of a transmitting side in a mobile communication system comprises receiving control information which indicates last re-transmission trial and data from a upper layer, transmitting discard information of the data to a MAC layer of a receiving side when re-transmission for the data fails.

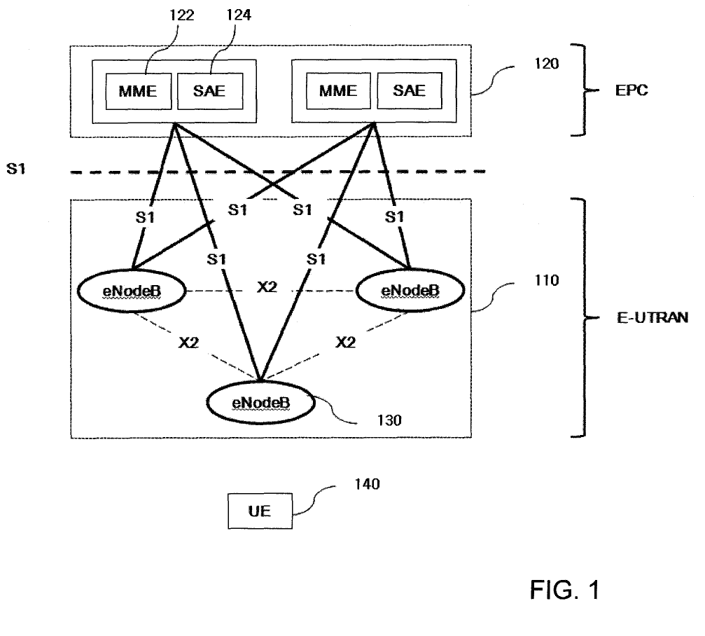

The present invention is applied to a mobile communication system, not limited to a LTE system. However, for explanation of embodiments, embodiments described later are referring to E-UMTS (Evolved Universal Mobile Telecommunications System) network structure and radio interface protocol drawings (FIG. 1 to FIG. 3) which are defined in LTE standard specifications.

FIG. 1 illustrates a network structure of an E-UMTS (Evolved-Universal Mobile Telecommunications System).

Referring to FIG. 1, E-UMTS includes an Evolved UMTS Terrestrial Radio Access Network 110 (hereinafter, abbreviated as ‘E-UTRAN’) and an Evolved Packet Core 120 (hereinafter, abbreviated as ‘EPC’).

E-UTRAN 110 includes one or more base stations 130 (hereinafter, referred to as ‘eNodeB’) wherein eNodeB 130 provides a radio interface protocol of user plane and control plane.

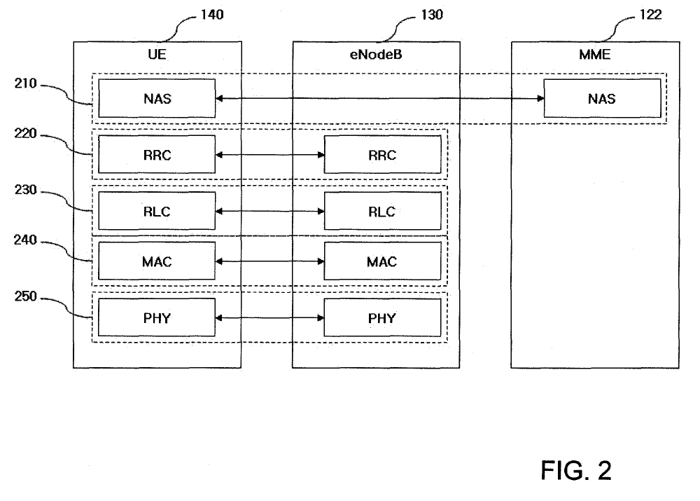

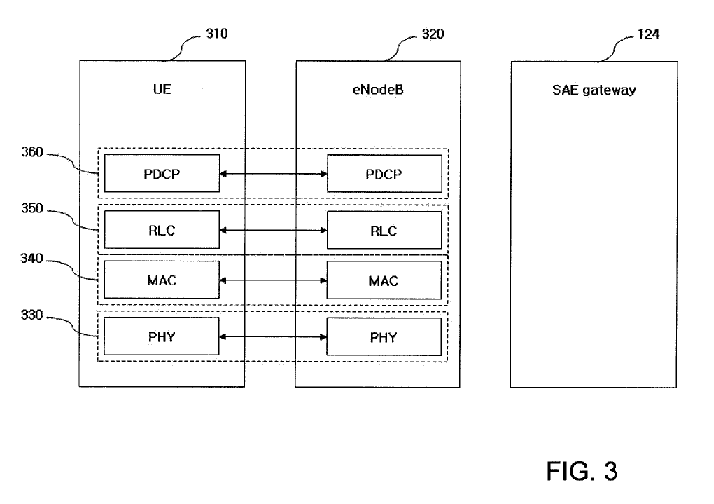

The radio interface protocol of user plane and control plane will be illustrated in FIG. 2 and FIG. 3 in detail.

EPC 120 may include a mobility management entity 122 (hereinafter, abbreviated as ‘MME’) which manages mobility and a system architecture evolution 124 (hereinafter, abbreviated as ‘SAE’) which manages data transmission.

The eNodeB 130 is connected with EPC 120 through S1 interface wherein the S1 interface comprises S1-MME interface connected with MME 122 and S1-U interface connected with SAE 124.

The respective eNodeBs are connected with each other through X2 interface for transmitting user traffic and control traffic.

FIG. 2 and FIG. 3 illustrates a structure of a radio interface protocol between a mobile terminal and E-UTRAN according to 3GPP radio access network.

FIG. 2 is a schematic view of a radio interface protocol of control plane according to 3GPP radio access network.

Referring to FIG. 2, control plane of radio interface protocol vertically includes a physical layer 250 (PHY), a medium access control (hereinafter, abbreviated as ‘MAC’) layer 240, a radio link control (hereinafter, abbreviated as ‘RLC’) layer 230 and a radio resource control (hereinafter, abbreviated as ‘RRC’) layer 220 and Non Access Stratum (hereinafter, abbreviated as ‘NAS’) layer 210.

The NAS layer 210 locates in UE 140 and MME 122 of EPC 120 and provides a function of transparently transmitting and receiving control message to an eNodeB 130.

The RRC layer 220 plays a role in controlling radio resources between the UE 140 and the eNodeB 130. Herein, the radio resources may include code, frequency and power and so on.

The RRC layer 220 can control the physical channel, transport channel and logical channel in order to configure, reconfigure and release of radio bearer (hereinafter, abbreviated as ‘RB’).

Herein, RB means a service provided by the second layer for the data transmission between mobile terminal and UTRAN. Herein, the second layer may include MAC 240 and RLC 230.

Moreover, the RRC layer 220 provides mobility management and power control of the UE 140.

The RLC layer 230 locates above the MAC layer 240 and supports reliable data transmission.

The RLC layer 230 of transmitting side provides a function of segmenting and concatenating RLC service data unit (hereinafter, abbreviated as ‘SDU’) delivered from above layer to form the RLC SDU into adjustable size for radio interface.

The RLC layer 230 of receiving side provides a function of reassembling a received RLC protocol data unit (hereinafter, abbreviated as ‘PDU’) to RLC SDU.

A respective RLC entity may be operated in one of transparent mode (hereinafter, abbreviated as ‘TM’), unacknowledged mode (hereinafter, abbreviated as ‘UM’), and acknowledged mode (hereinafter, abbreviated as ‘AM’) according to processing and transmission scheme of RLC SDU.

Layers of a radio interface protocol between a mobile terminal and a eNodeB 130 in a LTE system may be composed of three lower layers of open system interconnection (hereinafter, abbreviated as ‘OSI’) standard model widely known in communication systems.

Herein, the three lower layers can be classified into a first layer L1, a second layer L2 and a third layer L3.

Referring to FIG. 2, a physical layer as the first layer L1 may perform an information transfer service through radio interface using a physical channel. The physical channel is connected to a MAC layer 240 above the physical layer via transport channel. Data are transferred between the MAC layer 240 and the physical layer 250 via the transport channels.

The second layer comprises of an MAC layer 240 and an RLC layer 230.

The MAC layer 240 provides a data transmission service to the RLC layer 230 above the MAC layer 240 via logical channels.

The MAC layer 240 provides a mapping function between a logical channel and a transport channel, a traffic volume measurement and reporting, a transmission error correction through Hybrid ARQ (hereinafter, abbreviated as ‘HARQ’), a priority handling among logical channels of a mobile terminal, a priority handling among a plurality of mobile terminals using dynamic scheduling, and a transport format selection.

The RLC layer 230 supports reliable data transfer between end-points and provides AM/UM/TM service according to data characteristics and priority.

The RLC layer 230 performs a function of an automatic repeat request (hereinafter, abbreviated as ‘ARQ’) by receiving a control signal which indicates whether an packet error occurs. The control signal includes RLC ACK and/or RLC NACK.

The RRC layer 220 of the third layer performs controlling a radio resource allocated between the mobile terminal and the network.

The RRC layer 220 locates in eNodeB 130 and UE 140 respectively and exchanges a control information through pre-determined RRC message.

Referring to FIG. 2, the radio interface protocol vertically includes a PHY 250, a MAC layer 240, a RLC layer 230 and a RRC layer 220 and horizontally corresponds to a control plane for transferring a signaling message.

FIG. 3 is a schematic view of a radio interface protocol of user plane according to 3GPP radio access network.

Referring to FIG. 3, the radio interface protocol vertically includes an PHY 330, a MAC layer 340, a RLC layer 350 and a packet data convergence protocol (hereinafter, abbreviated as ‘PDCP’) layer 360 and horizontally corresponds to a user plane for data transfer. The respective layer of radio interface protocol in the user plane locates both an UE 310 and an eNodeB 320. The PHY 330, the MAC layer 340 and the RLC layer 350 included in the use plane may perform a function described in the FIG. 2.

In order to effectively transmit IP packets (e.g., IPv4 or IPv6) within a radio communication period having a narrow bandwidth, the PDCP layer 360 performs header compression to reduce the size of a relatively large IP packet header containing unnecessary control information.

The PDCP layer 360 which locates in the E-UTRAN 110, performs data packet ciphering.

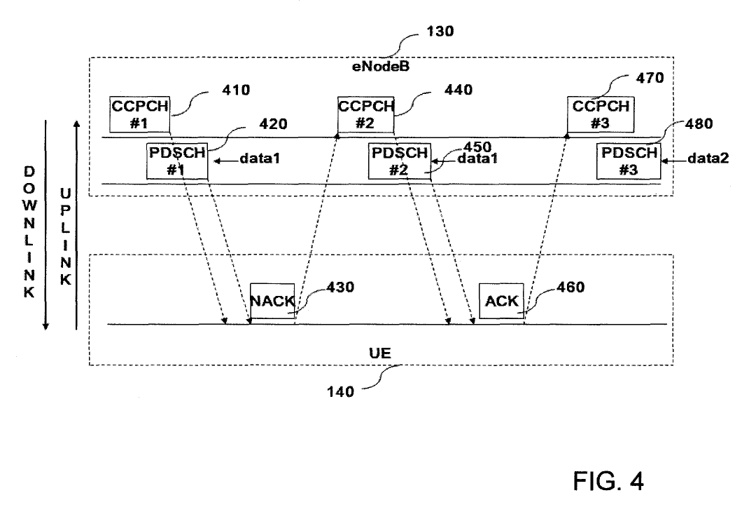

FIG. 4 illustrates HARQ operation in 3GPP radio access network.

Particularly, FIG. 4 illustrates HARQ operation applied to downlink physical layer in a mobile communication system according to the present invention.

In an LTE system, there are a downlink transport channel for transmitting data and control signal from a network to an UE 140 and a uplink transport channel for transmitting data and control signal from the UE 140 to the network (E-UTRAN) 110. Herein, the control signal comprises system information.

The downlink transport channel comprises a broadcasting channel (hereinafter, abbreviated as ‘BCH’) for transmitting system information and a downlink shared channel (hereinafter, abbreviated as ‘DL-SCH’) for transmitting user data and/or control message.

The downlink transport channel further comprises a multicast channel (hereinafter, abbreviated as ‘MCH’) for transmitting data to a specific group of mobile terminal.

The uplink transport channel comprises a random access channel (hereinafter, abbreviated as ‘RACH’) for establishing an initial call and registrating a location and a uplink shared channel (hereinafter, abbreviated as ‘UL-SCH’) for transmitting user data and/or control message.

Referring to FIG. 4, in a scheduling period, the eNodeB 140 determines how to transmit a packet data received from a upper layer to a UE 140 based on a channel quality corresponding to at least one UE 140 and priority information per UE 140.

The eNodeB 130 may determine a transmission scheme using a parameter (e.g., coding rate, modulation scheme, redundancy version information and data amount for transmission during a period).

The eNodeB 130 transmits a determined transmission scheme through a common control physical channel (hereinafter, abbreviated as ‘CCPCH#1’) 410 to the UE 140 before transmitting a data. The transmission scheme comprises a resource allocation information.

The eNodeB 130 further includes a UE identification information indicating resource allocation information for a UE 140 into the CCPCH#1 410.

The eNodeB 130 transmits a packet data through a physical downlink shared channel (hereinafter, abbreviated as ‘PDSCH#1’) 420 after transmitting CCPCH#1 410.

The UE 140 determines whether there is a packet for the UE 140 using the UE identification information included in the CCPCH#1 410.

When there is a packet for the UE 140, the UE 140 may de-modulate the PDSCH#1 420 using the resource allocation information included in the CCPCH#1 410.

When there is a error for the demodulated packet, the UE 140 transmits an NACK signal 430 indicating the error for the packet through a UL-SCH to the eNodeB 130.

When the demodulated packet is correct, the UE 140 transmits an ACK signal 460 indicating a normal reception for the packet through the UL-SCH to the eNodeB 130.

FIG. 4 illustrates a situation when the UE 140 does not receive the PDSCH#1 420 normally.

When the eNodeB 130 receives the NACK signal 430 from the UE 140, the eNodeB 130 re-transmits the corresponding packet at a proper time. At this time, the eNodeB 130 may utilize the same transmission scheme used for the previous packet data or select new transmission scheme for high transmission efficiency.

Referring to FIG. 4, the eNodeB 130 sequentially transmits CCPCH#2 440 and PDSCH#2 450 to re-transmit the PDSCH#1 420.

When the UE 140 receives a re-transmission packet (PDSCH#2) 450, the UE 140 modulates using chase combining or incremental redundancy for the previous packet which has error (PDSCH#1) 420 and PDSCH#2 450. The UE 140 detects whether a packet is the re-transmission packet or not using a New Data Indicator included in CCPCH#2 440.

When the UE 140 succeeds in demodulation using the PDSCH#1 420 and PDSCH#2 450, the UE 140 transmits an ACK signal 460 to the eNodeB 130.

When the eNodeB 130 receives the ACK signal 460, the eNodeB 130 schedules new packet and transmits the new packet to the UE 140.

The control information for newly scheduled packet is transmitted through CCPCH#3 470 and the corresponding packet data is transmitted through PDSCH#3 480.

As described above, an ARQ of RLC layer and an HARQ of MAC layer are used to provide reliability of data transmission. The transmission unit of the ARQ may be RLC PDU and the transmission unit of the HARQ may be transport block (hereinafter, abbreviated as ‘TB’).

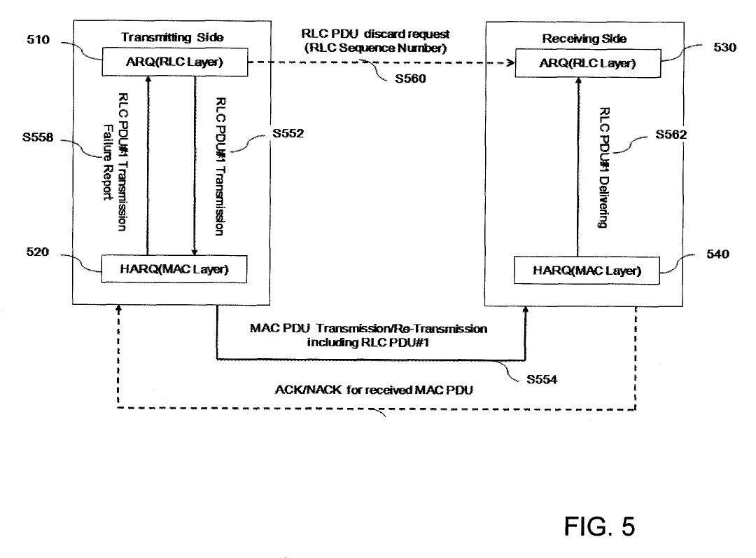

FIG. 5 illustrates a method for discarding the packet in case of failing to re-transmit in RLC layer according to a conventional art.

Referring to FIG. 5, an ARQ 510 which locates on an RLC layer of transmitting side delivers an RLC PDU having sequence number to an HARQ 520 which locates on an MAC layer of the transmitting side S552.

The RLC PDU includes at least one TB and the RLC PDU is delivered to the MAC layer of the transmitting side using a MAC-DATA-Request primitive.

The HARQ 520 of transmitting side generates an MAC PDU using the received RLC PDU and transmits the generated MAC PDU to an HARQ 540 which locates on an MAC layer of receiving side S554. The HARQ 540 of receiving side transmits an ACK signal or an NACK signal to the HARQ 520 of transmitting side depending on the status of the received MAC PDU S556.

It is assumed that the HARQ 540 of receiving side transmits consecutive NACK signals for the corresponding MAC PDU.

When the HARQ 520 of transmitting side receives the NACK signal, it re-transmits the corresponding MAC PDU. The maximum number of re-transmission may be fixed by a control signal received from an upper layer.

If the HARQ 520 of transmitting side fails to re-transmit the MAC PDU up to a predetermined maximum number, it stops re-transmitting for the MAC PDU.

The HARQ 520 of transmitting side delivers a control signal which indicates transmission failure of a RLC PDU corresponding to the MAC PDU for which re-transmission is stopped to the ARQ 510 of transmitting side S558. The control signal may be transmitted using a MAC-DATA-Confirm primitive. The MAC-DATA-Confirm primitive is a message to deliver a transmission result for an RLC PDU from the MAC layer to the RLC layer.

The ARQ 510 of transmitting side discards an RLC SDU which relates to the transmission failed RLC PDU and performs the following steps.

When the ARQ 530 of receiving side receives a discard request signal for the RLC PDU S560, it discards an RLC SDU which relates to the discard requested RLC PDU and processes RLC PDU delivered from the HARQ 540 of receiving side S562. The ARQ 530 of receiving side does not wait the discard requested RLC PDU and processes the received RLC PDU afterward.

As described above, a discard method for re-transmission failed RLC SDU in a conventional art takes too much time because the ARQ of transmitting side transmits a discard request signal for the RLC PDU to the ARQ of receiving side when it receives a transmission failed report for the last re-transmitted RLC PDU.

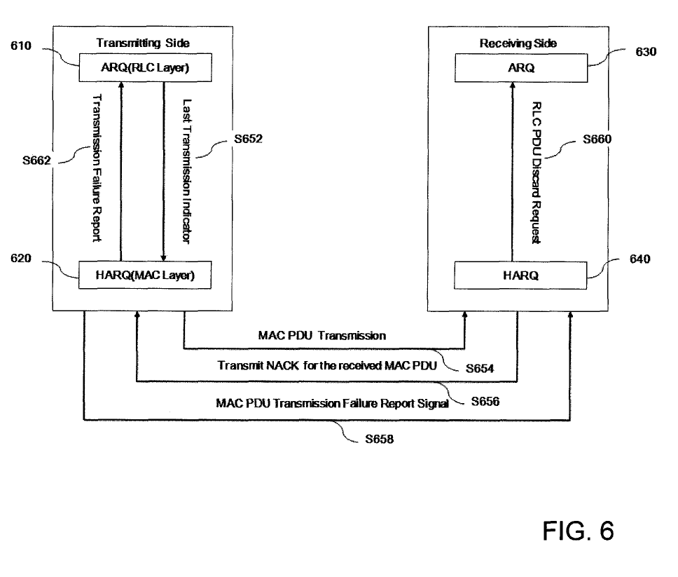

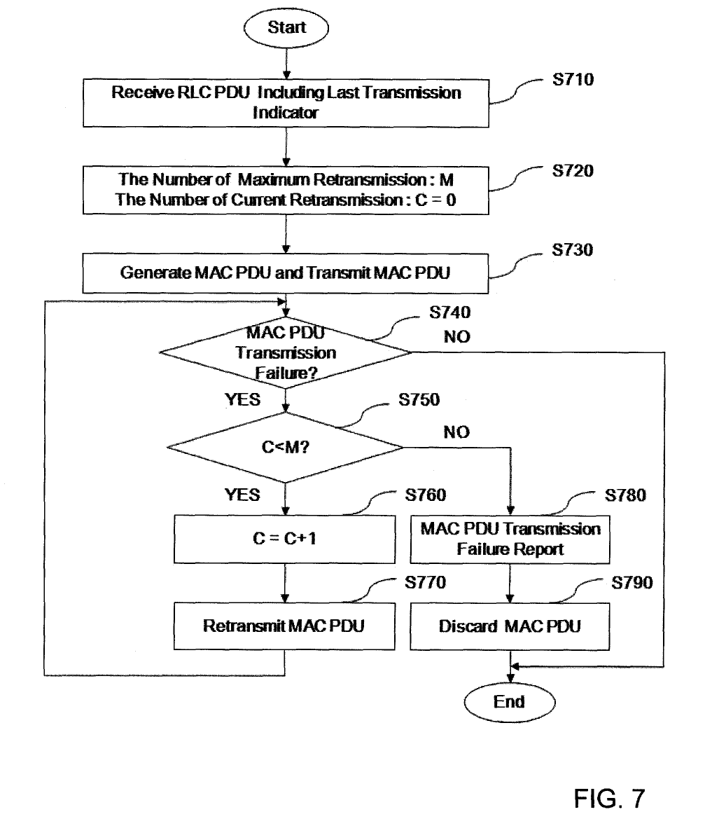

The method of controlling radio link data transmission according to one embodiment of the present invention will be described in detail referring to FIG. 6 and/or FIG. 7.

FIG. 6 illustrates a method of discarding a packet which fails to re-transmit according to one embodiment of the present invention.

Referring to FIG. 6, when a ARQ 610 of transmitting side delivers a last re-transmitted RLC PDU to a HARQ 620 of transmitting side, it also delivers an indicator indicating a last re-transmission to the HARQ 620 of transmitting side S652. The indicator may be called a last transmission indicator.

The ARQ 610 of transmitting side can delete a RLC SDU related to the last transmitted RLC PDU from a transmission buffer.

The HARQ 620 of transmitting side generates a MAC PDU using the received RLC PDU and transmits the MAC PDU to a HARQ 640 of receiving side S654.

The HARQ 640 of receiving side can line up the received MAC PDU using a transmission sequence number (hereinafter, abbreviated as ‘TSN’) which included in MAC PDU.

When there is an error for the received MAC PDU, the HARQ 640 of receiving side transmits an NACK signal to the HARQ 620 of transmitting side through a pre-configured uplink physical channel S656.

When the MAC PDU is normally received, the HARQ 640 of receiving side transmits an ACK signal to the HARQ 620 of transmitting side.

It is assumed that the HARQ 640 of receiving side consecutively transmits an NACK signal for the MAC PDU to the HARQ 620 of transmitting side.

The respective HARQ of transmitting side and receiving side performs above mentioned steps until the MAC PDU is successfully received by the receiving side.

Generally, the maximum number of re-transmission for a MAC PDU having a transmission sequence number may be limited.

If the HARQ 620 of transmitting side fails to re-transmit for the MAC PDU up to a predetermined maximum number of re-transmission, it transmits transmission failure report signal including a RLC PDU sequence number corresponding to the MAC PDU to the HARQ 640 of receiving side S658. The transmission failure report signal of the MAC PDU can be transmitted as a MAC control PDU format.

The HARQ 620 of transmitting side delivers transmission failure information of RLC PDU corresponding to the MAC PDU to the ARQ 610 of transmitting side S662. The transmission failure information can include RLC PDU sequence number and be delivered to the ARQ 610 of transmitting side using a MAC-DATA-Confirm primitive.

When the HARQ 640 of receiving side receives the transmission failure report signal of the MAC PDU, it delivers a RLC PDU discard request including the received RLC PDU sequence number to the ARQ 630 of receiving side S660.

The ARQ 630 of receiving side discards an RLC SDU corresponding to the sequence number and performs following steps.

FIG. 7 is a flow chart illustrating a method of discarding packet which fails to re-transmit according to one embodiment of the present invention.

Particularly, FIG. 7 is a flow chart illustrating the process step of a last re-transmitted RLC PDU of HARQ 620 in MAC layer of transmitting side.

Referring to FIG. 7, when a HARQ 620 of transmitting side receives RLC PDU including a last transmission indicator from a ARQ 610 of transmitting side S710, it initializes variables related to MAC PDU re-transmission S720. The variables comprises a maximum re-transmission number (M) of a MAC PDU and a current re-transmission number (C) of the MAC PDU. The maximum re-transmission number (M) is pre-configured by control signal received from upper layer.

The HARQ 620 of transmitting side generates MAC PDU using the received RLC PDU and transmits the generated MAC PDU through a downlink physical channel to the HARQ of receiving side S730.

The HARQ 620 of transmitting side determines whether the MAC PDU transmitted in S720 is failed or not S740.

When the transmission of the MAC PDU fails, the HARQ 620 of transmitting side compares the current re-transmission number (C) with the maximum re-transmission number (M) S750.

If the current re-transmission number (C) is less than the maximum re-transmission number (M), the HARQ of transmission side increments the C S760, re-transmits the transmission failed MAC PDU S770 and returns to S740.

In S740, if the MAC PDU is successfully transmitted, the HARQ 620 of transmitting side processes a MAC PDU waiting to be transmitted.

In S750, if the current re-transmission number (C) is equal or greater than the maximum re-transmission number (M), the HARQ 620 of transmission side transmits a transmission failed report of the MAC PDU including the sequence number of the RLC PDU received in S710 to HARQ 640 of receiving side S780, and discards the transmission failed MAC PDU S790.

When the transmission of the MAC PDU succeeds, the HARQ of transmitting side processes a waiting MAC PDU.

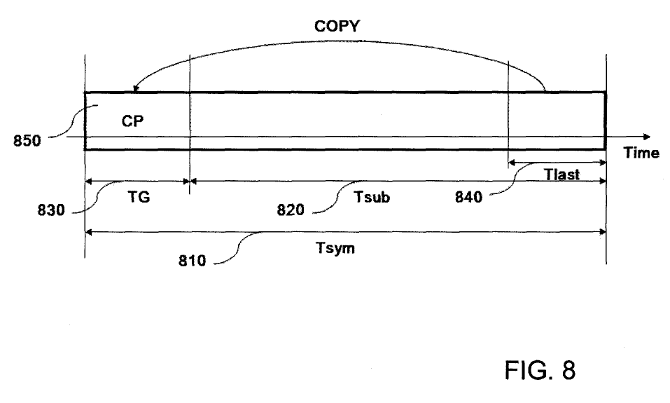

A random access procedure in a mobile communication system according to one embodiment of the present invention will be illustrated from FIG. 8 to FIG. 11 in detail.

Prior to description of random access procedure of a mobile terminal, an Orthogonal Frequency Division Multiplexing (hereinafter, abbreviated as ‘OFDM’) radio access scheme adapted in LTE will be described.

Generally, the OFDM is a modulation scheme that adjacent two subcarriers have orthogonal characteristic at overlapping period. In other words, the OFDM is a scheme allocating a subcarrier avoiding interference of other subcarrier at maximum value of respective subcarrier.

Therefore, the OFDM scheme has high frequency efficiency comparing with a conventional FDM scheme and provides a high speed data transmission.

Even though OFDM symbol transmission is processed in the unit of block, the same subcarriers which arrive at different time may cause inter-symbol interference (hereinafter, abbreviated as ‘ISI’) since the OFDM symbol experiences multi-path delay during radio transmission.

To prevent the ISI, the OFDM scheme inserts a guard interval (hereinafter, abbreviated as ‘GI’) between a consecutive OFDM blocks.

The GI length is longer than a maximum delay spreading of radio channel. In a receiving side, a received signal except GI will be de-multiplexed.

If a signal inserted into GI allocates ‘0’, a delay of previous symbol is completely absorbed and the ISI does not occur. However, there may be still inter-channel interference.

If all subcarriers are received without delay through radio channel, an orthogonal characteristic is maintained during fast fourier transform (hereinafter, abbreviated as ‘FFT’) period. However, if some subcarriers among N subcarriers are received with delay, the orthogonal characteristic is destroyed since the subcarriers do not maintain integral times period during a FFT interval.

Therefore, transmission delay generates inter-channel interference which causes distortion of another subcarrier and/or inter-symbol interference of the same subcarrier. Inserting a cyclic prefix (hereinafter, abbreviated as ‘CP’) in a guard interval resolves those problems.

FIG. 8 illustrates a method of inserting CP for preventing inter-symbol interference and inter-channel interference.

Referring to FIG. 8, one OFDM symbol interval (Tsym) 810 corresponds to a sum of a valid symbol interval (Tsub) 820 for transmitting data and a guard interval (TG) 830.

The last guard interval (Tlast) 840 of the valid symbol interval is duplicated and then inserted in the guard interval 830 as cyclic prefix (hereinafter, abbreviated as ‘CP’) to prevent destruction of orthogonal characteristics caused by subcarrier delay.

If the CP 850 is inserted into the OFDM symbol interval 810, the orthogonal characteristic is guaranteed even though some subcarriers are received with delay since the subcarriers maintain integral times period during a FFT interval.

There is a phase shift for a demodulated signal by delay. Therefore, there is no inter-channel interference. The CP insertion into guard interval decreases a bandwidth efficiency. However, it prevents waste of bandwidth followed by re-transmission because of inter-channel interference.

It is desirable to set a guard interval length to less than a quarter symbol interval even though the guard interval length is determined considering a maximum delay spreading of a channel.

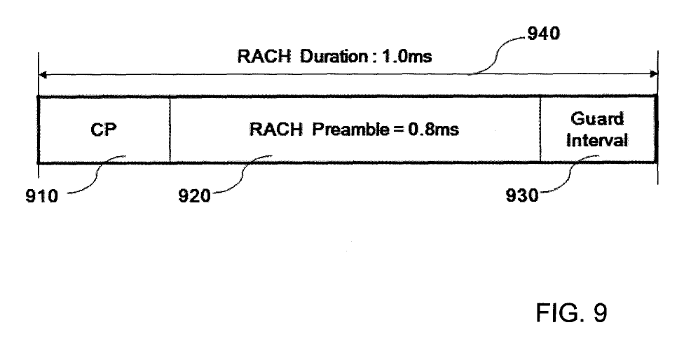

A frame structure per RACH type in LTE will be described later referring related drawings (FIG. 9 to FIG. 11) and related tables (Table 1 to Table 2).

FIG. 9 illustrates a structure of Basic RACH frame according to one embodiment of the present invention.

Referring to FIG. 9, the Basic RACH frame structure may include CP 910, RACH preamble 920, and guard interval 930. The Basic RACH interval 940 has a length of 1 ms.

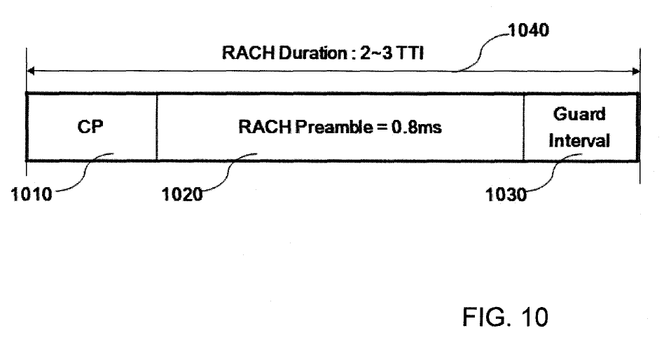

FIG. 10 illustrates a structure of Extended RACH frame according to one embodiment of the present invention.

Referring to FIG. 10, the Extended RACH frame has the same length of RACH preamble 920 of FIG. 9 and CP 1010 and guard interval 1030 which are longer than the Basic RACH frame.

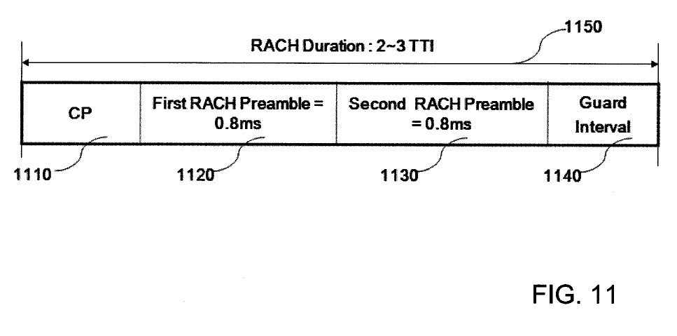

FIG. 11 illustrates a structure of Repeated RACH frame according to one embodiment of the present invention.

Referring to FIG. 11, the Repeated RACH frame structure has CP 1110, first RACH preamble 1120, second RACH preamble 1130, and guard interval 1140. The second RACH preamble 1130 can be a repeated pattern of the first RACH preamble 1120.

The CP consists of a long CP called Normal Cyclic Prefix and a short CP called Extended Cyclic Prefix.

In one transmission time interval (hereinafter, abbreviated as ‘TTI’), two slots are transmitted wherein one slot is comprised of the CP and OFDM symbol.

Considering the frame structure of RACH type 1 used in TDD/FDD, in case of short CP, the first CP is the longest and it alleviates the inter-symbol interference. Moreover, long CP is used in worst channel condition.

Considering the frame structure of type 2 used in TDD, in case of short CP, the first CP is the longest and it alleviates the inter-symbol interference. However, in case of long CP, the first CP is the longest and it is used in bad channel condition.

Considering a random access process in LTE system, 72 subcarriers are reserved for bandwidth of random access channel (RACH) and a RACH symbol interval allocated per subcarrier is larger than one TTI.

A mobile terminal obtains a system information by de-modulating BCH transmitted from eNodeB and starts random access procedure by using a RACH related information included in the system information.

In LTE system, the mobile terminal gains an uplink transmission timing synchronization using the random access procedure.

The eNodeB measures timing of a signal received from the mobile terminal and transmits the timing measurement result to the mobile terminal. Herein, the signal may be a RACH preamble and the timing measurement result includes a control parameter for adjusting uplink transmission timing.

The mobile terminal adjusts the uplink transmission timing using the timing measurement result and transmits a data to the eNodeB at the adjusted timing.

The table 1 describes a structure of RACH signal.

Considering the structure of RACH signal used for obtaining uplink transmission timing synchronization, the structure of RACH signal includes several kinds of signal structures like table 1 according to a supportable cell size.

TABLE 1

| Type | RACH length | RPF | Supportable cell size(km) |
|---|---|---|---|
| 0 | 1.0 ms | 1 | ~15 |
| 1 | 2.0 ms | 1 | ~90 |
| 2 | 2.0 ms | 2 | ~30 |
| 3 | 3.0 ms | 1 | ~120 |
| 4 | 3.0 ms | 2 | ~105 |

The table 1 can be described referring to table 2.

TABLE 2

| Frame Structure | Burst Type | TRA | TCP | TPRE |
|---|---|---|---|---|
| Type 1 | Normal | 30720xTs | 3152xTs | 24576XTs |
| | Extended | | | 24576XTs |
| | Repeated | | | 2x24576XTs |
| Type 2 | Normal | 4340xTs | 0xTs | 4096xTs |
| | Extended | 20736xTs | 0xTs | 20480xTs |

Referring to FIG. 9, a frame structure of Type 0 in table 1 is described below.

The type 0 of table 1 is a Basic RACH and corresponds to frame structure type 1 having normal burst type in table 2.

Referring to table 2, CP length (TCP) is a little longer than guard interval (TRA). And short CP length of next subframe is considered for guard time. The CP length is 102.6 us, the preamble length is 0.8 ms and the length of guard time is 97.4 us.

FIG. 10 illustrates a frame structure of type 1 in table 1.

The type 1 of table 1 is an Extended RACH and corresponds to frame structure type 1 having extended burst type in table 2.

The frame structure has 2˜3TTI RACH duration. When the RACH duration is 2TTI, the length of CP is 0.6 ms, the length of preamble is 0.8 ms and the length of guard time is 0.6 ms. In other words, the length of CP and the length of guard time are same.

FIG. 11 illustrates a frame structure of type 2 in table 1.

The type 2 of table 1 is a Repeated RACH and corresponds to frame structure type 1 having repeated burst type in table 2. The frame structure has 2˜3TTI RACH duration.

When the RACH duration is 2TTI, the length of CP is 0.2 ms, the length of respective preamble is 0.8 ms and the length of guard time is 0.2 ms. In other words, the length of CP and the length of guard time are same.

The type 3 of table 1 corresponds to frame structure type 2 having normal burst type in table 2. In this frame structure, random access burst begins guard interval (TRA) before the end of UpPTS. And the frame structure does not have CP.

The type 4 of table 1 corresponds to frame structure type 2 having extended burst type. In this frame structure, random access burst begins at the start point of uplink subframe 1. And the frame structure does not have the CP.

As described above, the mobile terminal begins random access procedure according to the cell size where the mobile terminal locates.

A physical layer of the mobile terminal cannot determine the type of table 1 itself, but determine a proper RACH type based on a RACH parameter obtained from system information at a RRC layer, radio channel condition, cell size, data size for transmission, available resource information, etc. Herein, determination of the RACH type may mean determination of RACH preamble format.

The RRC layer of the mobile terminal delivers a control message including the determined RACH type information to a transport layer, wherein the transport layer comprises the physical layer, MAC layer, etc.

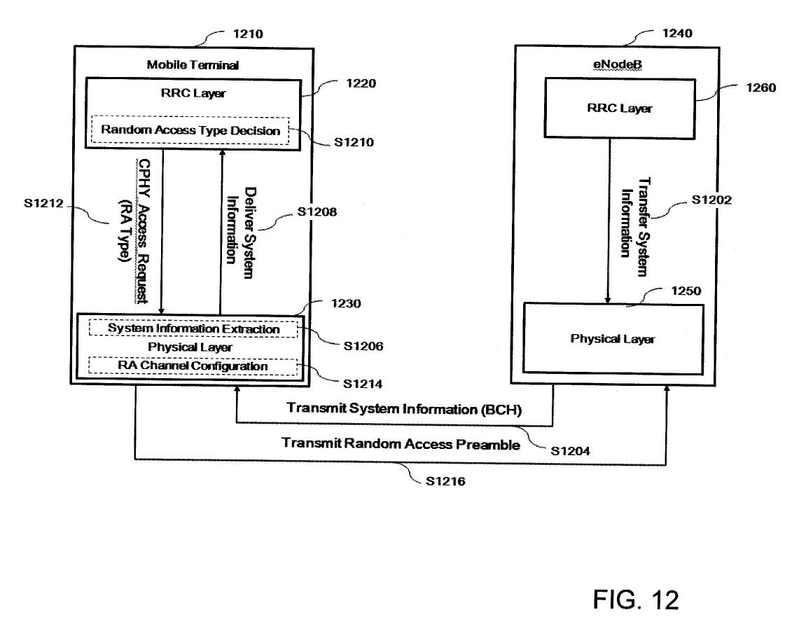

FIG. 12 is a flow chart illustrating a random access procedure according to one embodiment of the present invention;

Referring to FIG. 12, a RRC layer 1260 of a eNodeB 1240 delivers a system information of the related cell to a physical layer 1250 of the eNodeB 1240 S1202.

The physical layer 1250 of the eNodeB 1240 transmits the delivered system information through a channel S1204. For example, the channel may be a broadcasting channel (hereinafter, abbreviated as ‘BCH’).

A physical layer 1230 of a mobile terminal 1210 obtains a system information by de-modulating the BCH S1206. And the physical layer 1230 of a mobile terminal 1210 delivers the system information to a RRC layer 1220 of the mobile terminal 1210 S1208. The RRC layer 1220 of the mobile terminal 1210 determines random access type from the received system information S1210. And the RRC layer 1220 of the mobile terminal 1210 delivers CPHY-Access-Request including the random access type to the physical layer 1230 of the mobile terminal 1210 S1212.

The physical layer 1230 of the mobile terminal 1210 configures random access channel based on the received random access type information which means preamble type for random access S1214. And the physical layer 1230 of the mobile terminal 1210 transmits a random access preamble based on the random access type S1216.

According to one embodiment of the present invention, a RRC layer of a mobile terminal determines a random access type based on a system information received from a eNodeB.

Generally, a eNodeB may has at least one cell as a sector and each sector transmits a system information corresponding to the sector.

The system information is transmitted to a mobile terminal through a broadcasting channel and the system information comprises a cell size, and/or a random access information related to a random access procedure which is available at radio condition of the cell.

Herein, the random access information may comprises a type of table 1 and/or a frame structure and burst type information of table 2 which indicates a size of random access preamble.

The RRC layer of a mobile terminal determines a random access type for random access procedure and delivers a control message including the random access type information to a lower layer.

For example, the RRC layer of the mobile terminal delivers the determined random access type information through a CPHY-Config-Request primitive or CPHY-Access-Request primitive to a physical layer. And the physical layer performs random access procedure according to the received random access type information.

According to another embodiment of the present invention, a RRC layer of a mobile terminal determines a random access type based on a system information received from a eNodeB. And the RRC layer delivers the determined random access type information to a physical layer through a RLC layer and a MAC layer.

For example, the RRC layer of mobile terminal delivers RLC-Config-Request primitive including the random access type information to the RLC layer, and the RLC layer delivers MAC-Config-Request primitive including the random access type information to the MAC layer. Then, the MAC layer delivers PHY-Config-Request primitive including the random access type information to the physical layer.

According to another embodiment of the present invention, a mobile terminal determines a random access type based on a pilot strength received from eNodeB and/or a pilot transmission power information of eNodeB which is included in a system information.

For example, a mobile terminal can calculate a distance from a corresponding cell based on an attenuation of received pilot strength compared to a pilot transmission power of the corresponding cell. Therefore, the mobile terminal may determine a random access type based on the calculated distance.

Moreover, the mobile terminal further uses an uplink interference information included in a system information to calculate a distance from a corresponding cell. The uplink inference information indicates whether a current uplink channel condition is good or not. The mobile terminal can determine a proper random access type based on the current uplink channel condition.

According to another embodiment of the present invention, a RRC layer of a mobile terminal delivers a control signal including an available random access type to a lower layer and the lower layer can determine a proper random access type considering a gathered radio channel condition.

The description of the present invention is intended to be illustrative, and not to limit the scope of the claims. Many alternatives, modifications and variations will be apparent to those skilled in the art. The claims, means-plus-function clauses are intended to cover the structure described herein as performing the recited function and not only structural equivalents but also equivalent structures.

1-5. (canceled)

6. A method for performing random access procedure in a mobile terminal, the method comprising the steps of:
receiving a system information which includes an information for random access;
determining a random access preamble parameter based on the information for random access when random access procedure is triggered; and
configuring a random access preamble based on the random access preamble parameter.

7. The method as defined in claim 6, further comprising the step of transmitting the random access preamble on a reserved resource for random access.

8. The method as defined in claim 6, wherein the information for random access is generated by a radio resource control layer of a base station and transmitted to the mobile terminal through a downlink channel.

9. The method as defined in claim 6, wherein the random access preamble parameter comprises some or all of burst type, the length of cyclic prefix, the length of guard time, the length of preamble sequence and subframe number for transmitting the random access preamble.

10. The method as defined in claim 6, wherein the information for random access includes pre-defined random access type identifier for identifying random access preamble configuration.

11. The method as defined in claim 6, wherein the mobile terminal uses one or some of radio channel condition, cell size, data size for transmission and available resource information for determining the random access preamble parameter.

12. The method as defined in claim 6, wherein the random access preamble is generated at a physical layer corresponding to a random access preamble format selected by upper layer, wherein the upper layer includes a radio resource control layer and a media access control layer.

13. The method as defined in claim 6, wherein a value of the random access preamble parameter depends on a frame structure.

14. A method for performing random access procedure in a mobile communication systems, the method comprising the steps of:
forming a system information which includes at least one available RACH configuration information;
transmitting the system information through a downlink channel; and
receiving a random access preamble which is configured based on the RACH configuration information.

15. The method as defined in claim 14, wherein the RACH configuration information includes pre-defined random access type identifier for identifying random access preamble format.

16. The method as defined in claim 14, wherein the system information is formed at a radio resource control layer and transmitted to a mobile terminal through a physical downlink shared channel.

17. The method as defined in claim 14, wherein the system information is formed at a radio resource control layer and transmitted within a cell through a broadcasting channel.

18. A method for performing random access procedure in a mobile terminal, the method comprising the steps of:
receiving a first information from a base station;
determining a distance from the mobile terminal to the base station within a cell based on the first information;
determining a random access type based on the distance; and
configuring a random access preamble based on the random access type.

19. The method as defined in claim 18, wherein the first information comprises a downlink reference signal transmission power information and is included in a system information.

20. The method as defined in claim 19, wherein determining the distance includes measuring a received power level for the downlink reference signal and calculating a path loss using the transmission power information and the received power level.

21. The method as defined in claim 18, wherein the first information comprises uplink interference information.
